(19) United States
(12) Patent Application Publication
(10) Pub. No.: US 2026/0139739 A1
(43) Pub. Date: May 21, 2026

(54) COMPRESSIBLE SEALS WITH REDUCED COMPRESSION REQUIREMENTS

(71) Applicant: Lam Research Corporation, Fremont, CA (US)

(72) Inventors: Swajeeth Pilot Panchangam, Bengaluru (IN); Chetan Umaji Nayakawade, Kolhapur (IN); Nick Ray Linebarger, Jr., Tualatin, OR (US); Sushanth Sunilkumar Shetty, Udupi (IN)

(21) Appl. No.: 19/121,962

(22) PCT Filed: Oct. 18, 2023
(86) PCT No.: PCT/US2023/077235

§ 371 Date: Apr. 17, 2025

Related U.S. Application Data
(60) Provisional application No. 63/380,175, filed on Oct. 19, 2022.

(51) Int. Cl. F16J 15/08

(52) U.S. Cl. CPC F16J 15/0893

(57) ABSTRACT

This disclosure pertains to compressible metal seals that have cross-sectional shapes that include a circular exterior profile and a non-circular interior profile. Such seals may require lower compressive force compared to annular-shaped cross-sectional shapes for the same amount of compression and may also exhibit longer seal path lengths than annular-shaped cross-sectional shapes at equivalent amounts of compressive force.

### RELATED APPLICATION(S)

A PCT Request Form is filed concurrently with this specification as part of the present application. Each application that the present application claims benefit of or priority to as identified in the concurrently filed PCT Request Form is incorporated by reference herein in its entirety and for all purposes.

### BACKGROUND

Equipment that needs to maintain one or more regions higher or lower pressures as compared with adjacent regions may sometimes require the use of one or more seals in interfaces between two separate components that may form part of the boundary of the higher- or lower-pressure region. Various types of seals are available, including O-rings, C-seals, W-seals, crushable metal seals, etc.

In equipment that has very exacting requirements with regard to potential leak rates, e.g., semiconductor processing chambers that must maintain a very low vacuum environment and/or operate at elevated temperatures, it may be desirable to use certain types of seals that provide for a more resilient seal. Compressible metal O-rings are one example of such seals, and typically take the form of loop of circular tubing that is shaped to follow a desired seal path. When such a compressible metal seal is then compressed between two surfaces in order to seal the interface between those surfaces, the compression on the seal causes the circular tubing that forms the seal to deform, e.g., compressing by about 20%, and thereby generate a high contact stress between the top and bottom surfaces of the seal and the surfaces compressed against them.

### SUMMARY

Details of one or more implementations of the subject matter described in this specification are set forth in the accompanying drawings and the description below. Other features, aspects, and advantages will become apparent from the description, the drawings, and the claims.

In some implementations, an apparatus may be provided that includes a segment of compressible material. The segment of compressible material may have a constant cross-sectional shape along a first path, the cross-sectional shape may have an exterior profile and an interior profile, the exterior profile may have a nominally circular shape of radius R, the interior profile may have a non-circular shape with a maximum dimension along a first reference axis that intersects the interior profile at two locations, the interior profile may have a transverse dimension along a second reference axis that is perpendicular to the first axis and positioned midway between the two locations where the first reference axis intersects the interior profile, and the maximum dimension may be larger than the transverse dimension.

In some implementations, the maximum dimension may be greater than or equal to 1.6·R and less than or equal to 1.8·R, and the transverse dimension may be greater than or equal to 1.4·R and less than or equal to 1.6·R.

In some implementations, the maximum dimension may be about 1.8·R and the transverse dimension may be about 1.4·R.

In some implementations, the maximum dimension may be about 1.8·R and the transverse dimension may be about 1.5·R.

In some implementations, the maximum dimension may be about 1.8·R and the transverse dimension may be about 1.6·R.

In some implementations, the maximum dimension may be about 1.7·R and the transverse dimension may be about 1.4·R.

In some implementations, the maximum dimension may be about 1.7·R and the transverse dimension may be about 1.5·R.

In some implementations, the maximum dimension may be about 1.7·R and the transverse dimension may be about 1.6·R.

In some implementations, the maximum dimension may be about 1.6·R and the transverse dimension may be about 1.4·R.

In some implementations, the maximum dimension may be about 1.6·R and the transverse dimension may be about 1.5·R.

In some implementations, the interior profile may be symmetric across both the first reference axis and the second reference axis.

In some implementations, the interior profile may be divided into four quadrants by the first reference axis and the second reference axis, and the portion of the interior profile within each quadrant may have a maximum slope angle change of 90° or less.

In some implementations, the cross-sectional shape may have first thicknesses defined by distances between the interior profile and the exterior profile along the first reference axis and second thicknesses defined by distances between the interior profile and the exterior profile along the second reference axis, and the second thicknesses may each be at least 25% larger than the first thicknesses.

In some such implementations, the second thicknesses may each be no more than 200% larger than the first thicknesses.

In some implementations, the interior profile may lie entirely within a region bounded by an outer perimeter and an inner perimeter, the outer perimeter may be offset radially outward from a reference interior profile by 0.05·R, the inner perimeter may be offset radially inward from the reference interior profile by 0.05·R, and the first reference axis and the second reference axis may intersect at an intersection point. In such implementations, the reference interior profile may be a closed spline that passes through a set of eight points, the set of eight points including: two points that are positioned on either side of the intersection point and along the first reference axis such that each is at a distance X from the intersection point, two points that are positioned on either side of the intersection point and along the second reference axis such that each is at a distance Y from the intersection point, two points that are positioned on either side of the intersection point and along a third reference axis such that each is at the distance Y from the intersection point, wherein the third reference axis is at a 60° angle with respect to the first reference axis, and two points that are positioned on either side of the intersection point and along a fourth reference axis such that each is at the distance Y from the intersection point, wherein the fourth reference axis is a mirror image of the third reference axis with respect to the second reference axis. Furthermore, in such implementations, X may be equal to 0.85·R and Y may be equal to 0.75·R.

In some implementations, the segment may be a closed loop.

In some implementations, the segment may follow a path that defines the closed loop, the path may define a reference plane, and the second reference axis may be nominally perpendicular to the reference plane.

In some such implementations, the path may be circular.

In some such implementations, the path may be obround.

In some implementations, the path may be rectangular and may have rounded corners.

In some implementations, there may be no solid material within the interior profile.

In some implementations, the interior profile and the exterior profile may both be closed profiles.

In some implementations, the compressible material may be a metal.

In some implementations, the compressible material may be Inconel-718, Hastelloy C22, SS-316L stainless steel, oxygen-free electronic (OFE) copper, or other similar metallic material.

In some implementations, R may be a value greater than or equal to 1 mm and less than or equal to 25 mm.

In some implementations, the apparatus may further include a first component of a semiconductor processing tool and a second component of the semiconductor processing tool and the segment of compressible material may be compressed between the first component and the second component so as to form a sealed interface between the first component and the second component.

### BRIEF DESCRIPTION OF THE DRAWINGS

Reference to the following Figures is made in the discussion below; the Figures are not intended to be limiting in scope and are simply provided to facilitate the discussion below.

FIG. 1 depicts an example circular metal O-ring seal.

FIG. 2 depicts an example obround metal O-ring seal.

FIG. 3 depicts an example rectangular metal O-ring seal.

FIG. 4 depicts a representative cross-sectional shape.

FIG. 5 depicts a cross-sectional shape similar to that of FIG. 4 but with quadrants indicated.

FIG. 6 depicts an example of a cross-sectional shape of seals discussed herein in which thicknesses between an interior profile and an exterior profile are indicated.

FIG. 7 depicts an example of a region within which an interior profile of a cross-sectional shape of a seal as disclosed herein may be bounded.

FIG. 8 depicts eight examples of cross-sectional shapes that have interior profiles that fall entirely within a region such as is depicted in FIG. 7.

FIG. 9 depicts a diagram of a semiconductor processing chamber implementing a metal O-ring seal as discussed herein.

The above-described Figures are provided to facilitate understanding of the concepts discussed in this disclosure, and are intended to be illustrative of some implementations that fall within the scope of this disclosure, but are not intended to be limiting-implementations consistent with this disclosure and which are not depicted in the Figures are still considered to be within the scope of this disclosure.

### DETAILED DESCRIPTION

As noted previously, one type of seal that may be commonly used in semiconductor processing equipment is the compressible metal seal, e.g., metal O-ring seals. Metal O-ring seals provide high performance against potential leaks at both very low pressures, e.g., ultra high vacuum below 10⁻¹⁰ mbar, and high temperatures, e.g., temperatures up to or more than 400° C. Such seals may be used to seal between two components of a semiconductor processing tool, e.g., between a chamber and a chamber lid, between a chamber and a valve body, between a chamber and a flanged pipe fitting, etc. However, metal O-ring seals may provide difficult to install, as the amount of force needed to permanently crush a metal O-ring seal, thereby causing it to seal, may actually be quite significant. This presents potential issues for installers, as it may be difficult or time-consuming to properly compress such seals when installing them, particularly in the field.

The present inventors conceived of a new type of metal O-ring seal that, due to its internal profile, requires significantly less compression force to install than equivalent metal O-rings that have circular internal profiles while at the same time providing increased radial seal path length and thus a more effective seal. This has the added benefit of reducing the potential that a metal O-ring seal (or similar metal seal) might damage the components being sealed. For example, the compressive forces required to install a conventional metal O-ring seal may be high enough that components that are made of softer materials, e.g., aluminum or copper, may actually be locally deformed by the compressive stresses that may be required to cause a metal O-ring seal to deform into its sealed configuration. For example, two components that have two flat mating surfaces may be sealed together by a metal O-ring seal that is placed in a corresponding groove in one of those flat surfaces. The groove may be sized to have a depth that is slightly less than the thickness of the metal O-ring seal so that when the two flat surfaces are clamped together and brought into contact, the metal O-ring seal is compressed to a desired amount that results in the permanent deformation of the metal O-ring seal necessary for the metal O-ring seal to achieve an effective seal.

However, if the component with the groove is made of a softer material, such as aluminum, the local compressive forces generated between the metal O-ring seal and the bottom of the groove may be sufficient to cause the bottom of the groove to plastically deform, e.g., forming an impression in the floor of the groove that, in effect, deepens the depth of the groove. When the metal O-ring seal is removed, the impression may remain. Each new metal O-ring seal that is then placed in the same seal interface and compressed will a) permanently deform the floor of the groove a little more, thereby increasing the depth of the groove, and/or b) be compressed to a lesser extent than the most recently installed previous metal O-ring seal due to the increasing depth of the groove. Eventually the amount of compression that may be exerted on a newly installed metal O-ring seal before the two flat surfaces are clamped together (thereby preventing further compression of the metal O-ring seal) may be insufficient to achieve a desired amount of compression in the metal O-ring seal necessary to provide an effective seal. Once this occurs, the component with the groove will need to be replaced or repaired. Similar issues may also affect the component that does not have the groove, of course.

The reduced clamping forces required to make an effective seal in the metal O-ring seals discussed herein may reduce the risk of such damage/permanent deformation in softer materials, thereby allowing metal O-ring seals to be used with parts made of aluminum or copper, for example, with reduced risk of such parts needing to be repaired or replaced when changing seals.

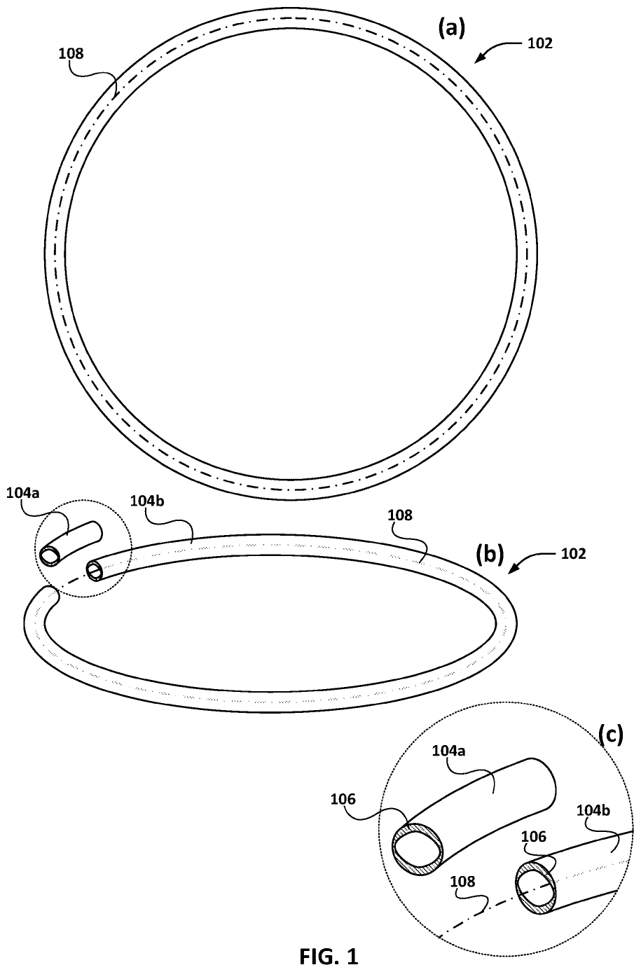

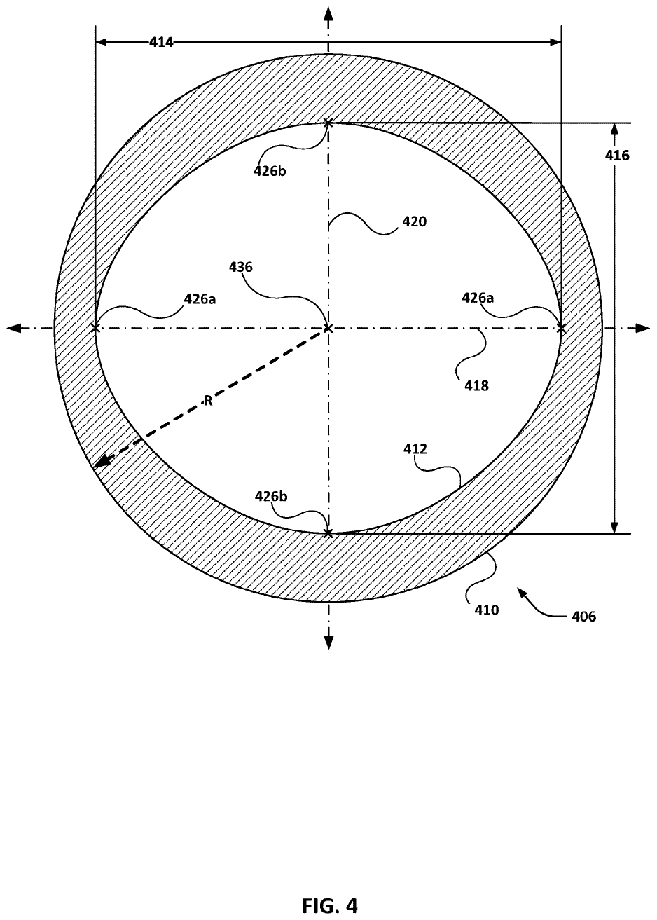

Several examples of such seals are discussed below with respect to FIGS. 1 through 3, while FIG. 4 onwards discuss particular characteristics and attributes of such seals.

FIG. 1 depicts a circular metal O-ring seal according to this disclosure. As can be seen from part (a) of FIG. 1, the seal 102 follows a circular path 108. Part (b) of FIG. 1 depicts a dimetric view of the seal 102 with a segment 104a of the seal cut and removed from a larger segment 104b of the seal to allow the cross-sectional shape 106 of the seal 102 to be seen. Part (c) of FIG. 1 is a detail view of the segment 104a and a portion of the segment 104b circled by a dotted line in part (b) of FIG. 1.

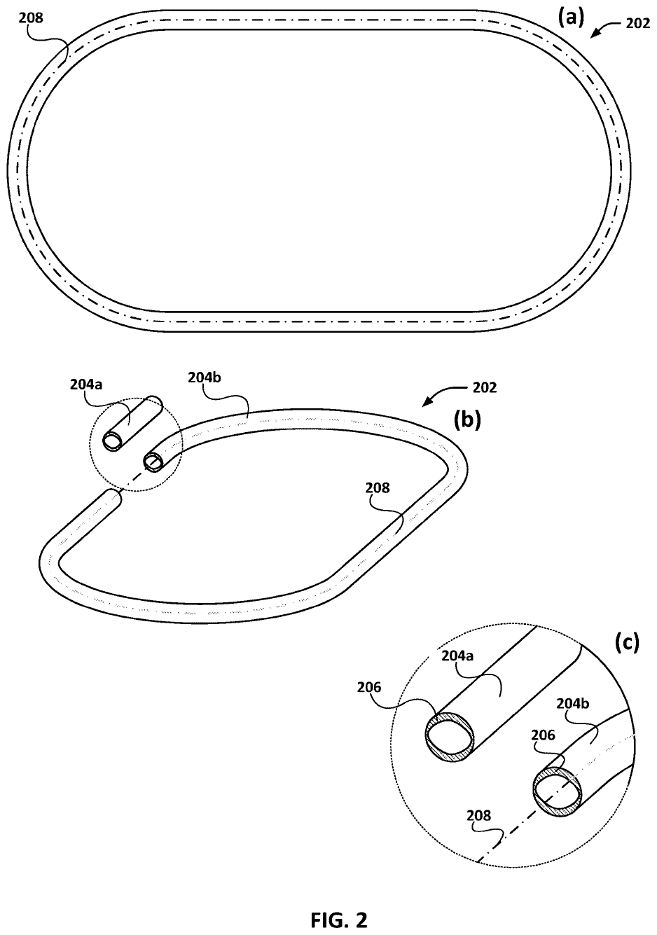

FIG. 2 depicts an obround metal O-ring seal according to this disclosure. As can be seen from part (a) of FIG. 2, the seal 202 follows an obround path 208. Part (b) of FIG. 2 depicts a dimetric view of the seal 202 with a segment 204a of the seal cut and removed from a larger segment 204b of the seal to allow the cross-sectional shape 206 of the seal 202 to be seen. Part (c) of FIG. 2 is a detail view of the segment 204a and a portion of the segment 204b circled by a dotted line in part (b) of FIG. 2.

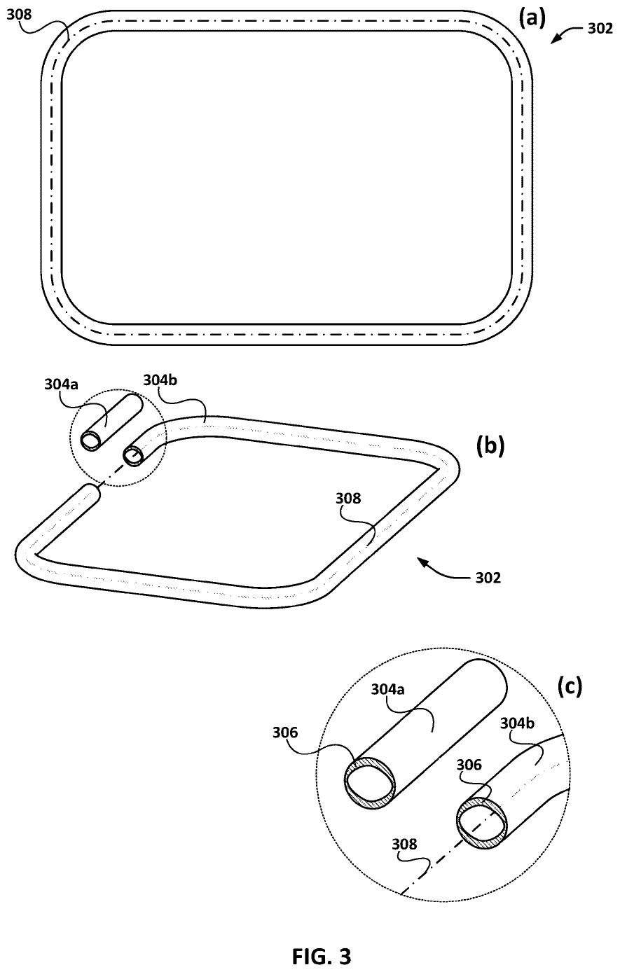

FIG. 3 depicts a rectangular metal O-ring seal according to this disclosure. As can be seen from part (a) of FIG. 3, the seal 302 follows a rectangular path 308 having rounded corners. Part (b) of FIG. 3 depicts a dimetric view of the seal 302 with a segment 304a of the seal cut and removed from a larger segment 304b of the seal to allow the cross-sectional shape 306 of the seal 302 to be seen. Part (c) of FIG. 3 is a detail view of the segment 304a and a portion of the segment 304b circled by a dotted line in part (b) of FIG. 3.

It will be understood that all of the example seals in FIGS. 1 through 3 have the same cross-sectional shapes that feature a circular exterior profile coupled with a non-circular interior profile. Segments of compressible material, e.g., metal, having such cross-sectional shapes (or shapes similar thereto) may be shaped so as to follow any desired two-dimensional path—assuming the path does not contain overly small corners—in order to produce a seal. Thus, there may be seal shapes other than the circular, obround, and rectangular shapes shown in FIGS. 1 through 3 that fall within the scope of this disclosure. Such seals may generally have a constant cross-sectional shape along their lengths (or at least along part of their lengths).

FIG. 4 depicts a cross-sectional shape 406 that is representative of the cross-sectional shapes 106 through 306. As can be seen, the cross-sectional shape 406 has an exterior profile 410 that is circular and has a radius “R.” The cross-sectional shape 406 also has an interior profile 412 that is non-circular in shape. The interior profile 412 has a maximum dimension 414 that effectively defines a first reference axis 418. For example, there will be two locations 426a on the interior profile 412 that are the two points along the interior profile 412 that are the furthest apart. The first reference axis 418 is an axis that passes through the two locations 426a, and the maximum dimension 414 is the distance between the two locations 426a.

The interior profile 412 may also have a transverse dimension 416 that measures the distance between two locations 426b that mark where a second reference axis 416 that is perpendicular to the first reference axis 418 and midway between the locations 426a intersects the interior profile 412.

Generally speaking, the maximum dimension may be larger than the transverse dimension. For example, the maximum dimension may be greater than or equal to 1.6·R and less than or equal to 1.8·R while the transverse dimension may be greater than or equal to 1.4·R and less than or equal to 1.6·R but also less than the maximum dimension.

In some implementations, the maximum dimension may be about 1.8·R and the transverse dimension may be about 1.4·R. In other implementations, the maximum dimension may be about 1.8·R and the transverse dimension may be about 1.5·R. In yet other implementations, the maximum dimension may be about 1.8·R and the transverse dimension may be about 1.6·R. In yet further implementations, the maximum dimension may be about 1.7.R and the transverse dimension may be about 1.4·R. In yet more implementations, the maximum dimension may be about 1.7.R and the transverse dimension may be about 1.5·R. In yet other implementations, the maximum dimension may be about 1.7·R and the transverse dimension may be about 1.6·R. In yet additional implementations, the maximum dimension may be about 1.6·R and the transverse dimension may be about 1.4·R. In yet further implementations, the maximum dimension may be about 1.6·R and the transverse dimension may be about 1.5·R.

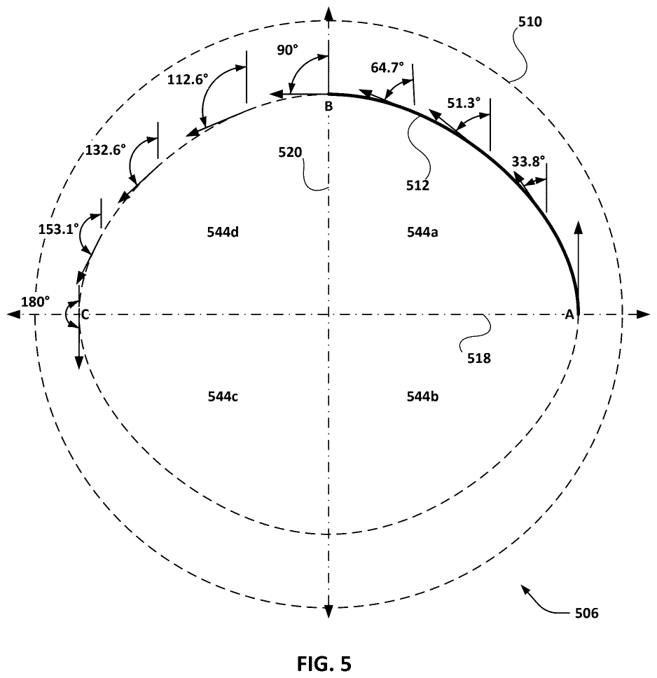

In at least some implementations, the interior profile may be symmetric across both the first reference axis and the second reference axis. The first reference axis 418 and the second reference axis 420 may also divide the interior profile 412 into four quadrants. For example, FIG. 5 depicts a cross-sectional shape similar to that of FIG. 4 but with quadrants 544a-d indicated. The first reference axis 518 and the second reference axis 520 define boundaries between each quadrant 544a-d. As can be seen, the interior profile 512 is divided up into four different portions, each located in a different one of the quadrants 544a-d. The portion of the interior profile 512 that lies within quadrant 544a is shown as a heavy solid line while the remainder of the cross-sectional shape is shown in broken lines. The portion of the interior profile 512 that lies within quadrant 544a has also been augmented to show several (five) rays emanating off of it in a tangent manner. The first ray is tangent to the interior profile 512 where it intersects with the first reference axis 518 (and is thus perpendicular to the first reference axis 518) while the last ray is tangent to the interior profile 512 where it intersects with the second reference axis 520 (and is thus at a right angle with respect to the second reference axis 520). It will be observed that the maximum slope angle change of the portion of the interior profile 512 that lies within quadrant 544a in some implementations is 90°. To be clear, the maximum slope angle change of a segment of a curve is the difference between the maximum and minimum slope angles that a ray that is tangent to the curve experiences when the endpoint of the ray is moved along the curve from one end of the curve to the other while maintaining tangency to the curve. For example, the maximum slope angle change from point A to point B along the interior profile 512 segment lying in quadrant 544a is 90°, while the maximum slope angle change from point A to point C along the interior profile 512 segments lying in quadrants 544a and 544d is 180°.

In some implementations, the interior profile may be defined such that the wall thicknesses between the interior profile and the exterior profile at locations where the first reference axis and the second reference axis intersect the cross-sectional shape exhibit particular characteristics.

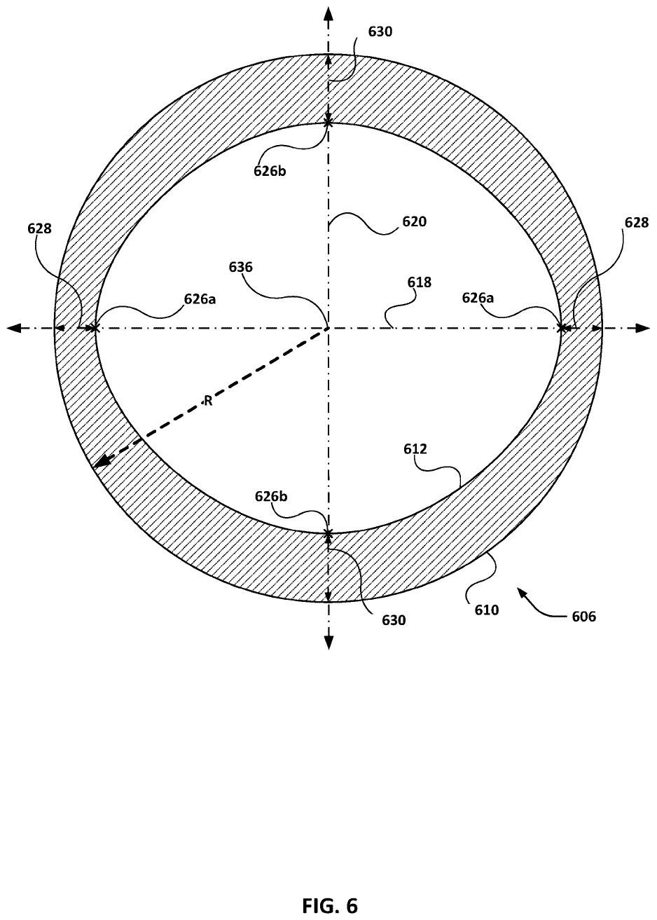

FIG. 6 depicts an example of a cross-sectional shape of the seals discussed herein in which the thicknesses between the interior profile and the exterior profile are indicated. As can be seen in FIG. 6, the cross-sectional shape 606 has an exterior profile 610 and an interior profile 612. The exterior profile 610 is circular and has a radius R, while the interior profile 612 is non-circular. As with the cross-sectional shape 406, the cross-sectional shape 606 may have a first reference axis 618 that passes through the two locations 626a that lie along the interior profile 612 and are spaced the greatest distance apart. A second reference axis 620 that is perpendicular to the first reference axis 618 and positioned midway between the locations 626a may intersect with the interior profile 612 at locations 626b and with the first reference axis 618 at intersection point 636.

As can be seen, there are first thicknesses 628 between the interior profile 612 and the exterior profile 610 at the locations 626a and second thicknesses 630 between the interior profile 612 and the exterior profile 610 at the locations 626b. The first thicknesses 628 and the second thicknesses 630 are respectively aligned with the first reference axis 618 and the second reference axis 620. In some implementations, the second thicknesses 630 may each be at least 25% larger than either of the first thicknesses 628. In some additional such implementations, the second thicknesses 630 may each be no more than 200% larger than the first thicknesses 628.

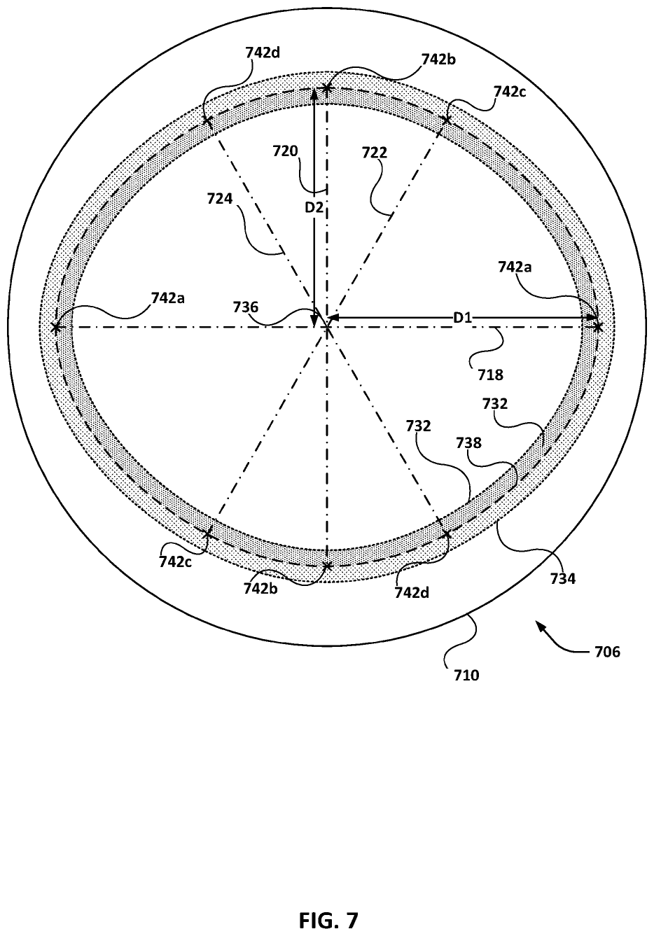

In some implementations, the interior profile may fall within a region defined relative to a reference profile. FIG. 7 depicts an example of a region within which an interior profile of a cross-sectional shape of a seal as disclosed herein may be bounded. As can be seen in FIG. 7, a cross-sectional shape 706 is depicted that has an exterior profile 710 that is circular and has a radius R. The depicted cross-sectional shape 706 does not have an interior profile depicted but does have a reference interior profile 738 depicted. The reference profile 738 is defined by a closed spline, e.g., as may be drawn in a computer-aided design program such as PTC Creo or SolidWorks, that passes through eight points 742a-742d (two of each point are depicted). An outer perimeter 734 and an inner perimeter 736 may both be offset radially outward or radially inward, respectively, from the reference interior profile 738 by a common distance, e.g., 0.05·R, and may bound a region 732 (shown as two differently shaded regions bracketing the reference interior profile 738 between them).

The closed spline of the reference interior profile 738 may have bilateral symmetry across a first reference axis 718 and across a second reference axis 720 that is perpendicular to the first reference axis. Two additional reference axes, a third reference axis 722 and a fourth reference axis 724, that both pass through an intersection point 735 between the first reference axis 718 and the second reference axis 720 and are both at 30° angles with respect to the second reference axis 720 (or at 60° angles with respect to the first reference axis 718).

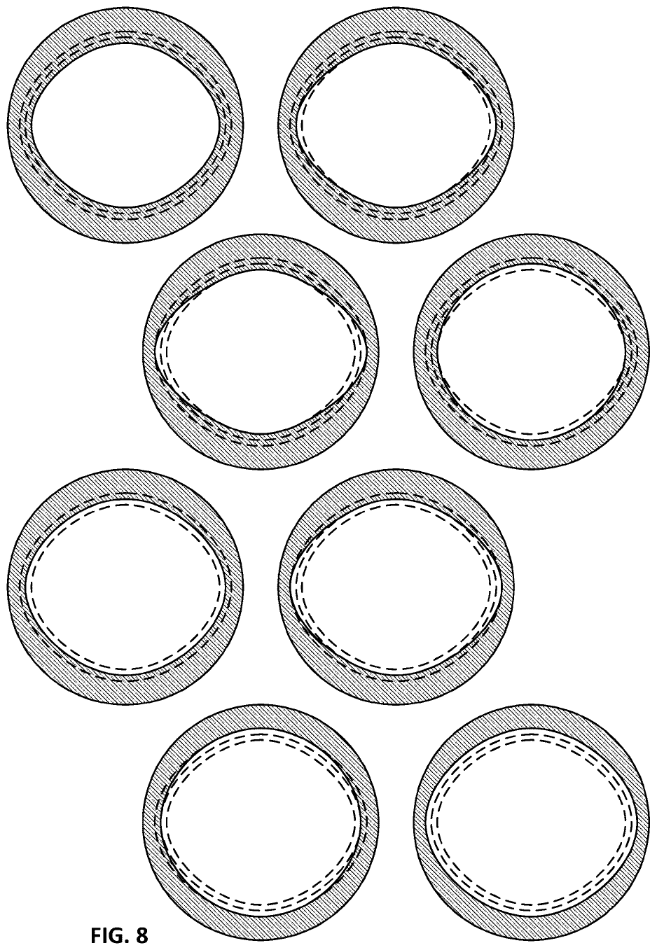

Each pair of points 742a-742d may be positioned along a respective one of the four reference axes 718 through 724 with the intersection point 736 midway between them. For example, the two points 742a may be positioned along the first reference axis 718 such that they are both a distance X from the intersection point 736. At the same time, the points 742b may be positioned along the second reference axis 720 at a distance Y from the intersection point 736. The points 742c and 742d may similarly be positioned along the third reference axis 722 and the fourth reference axis 724, respectively, each at the distance Y from the intersection point 736. In some implementations, the interior profile for such a cross-sectional shape for a seal according to this disclosure may be any profile that falls entirely within the region 732 when X is equal to 0.85·R and Y is equal to 0.75·R. FIG. 8 depicts eight examples of cross-sectional shapes that have interior profiles that fall entirely within a region such as the region 732. As can be seen, there is some latitude as to the exact shape of the interior profile, although the benefits of reduced compressive force needed to set the seal and greater seal path length may still accrue to each of the depicted implementations (although to a greater extent for some than compared to others).

In a typical metal O-ring seal, the cross-sectional shape of the seal (taken in a plane that is perpendicular to the path that the seal follows) is perfectly annular, i.e., having a circular external profile and a circular interior profile that is concentric with the external profile. As will be clear from the above discussion and examples, the seals disclosed herein have interior profiles that are not circular and which exhibit particular geometric characteristics relating to wall thickness, profile shape, and/or maximum dimensions. Such seals may exhibit superior performance with regard to requiring lower compressive force in order to set the seal as well as increased seal path length. The seal path length refers to the shortest distance across which the seal and the surfaces that compress it are in full contact and generally represents the shortest distance that gas must traverse in order to leak past the seal. The longer the seal path length is, the more difficult it is for gas to leak past the seal.

For example, simulations were performed of a seal having a cross-sectional shape similar to that of example C in FIG. 8 and a similarly sized seal having a circular interior profile (a conventional compressible metal seal) in which both seals had exterior profile diameters of 13 mm and were made of an aluminum alloy having a density of 2700 kg/cubic meter, a Young's modulus of 68 GPa, a Poisson's ratio of 0.33, and a friction coefficient of 0.3. It was observed that the seal with the cross-sectional shape of example C in FIG. 8, when subjected to a compression force of approximately 7300 lb/in (compression force per inch of seal length) developed a seal path length that was almost 50% (48%) longer (1.32 mm vs. 0.89 mm) than that developed in the conventional cross-section seal under a load of approximately 8000 lb/in (compression force per inch of seal length). At the same time, the seal with the cross-sectional shape of example C in FIG. 8 underwent 0.02 inches of displacement at that load compared with only 0.004 inches of displacement in the conventional seal. In other words, the seal with the cross-sectional shape of example C in FIG. 8 is able to compress 400% more, and achieve a seal path length ˜50% longer than, a conventional compressible metal seal subjected to a similar compressive load. To achieve a similar seal path length, the example conventional compressible metal seal would need to be subjected to approximately 50% more compressive load than the seal with the cross-sectional shape of example C in FIG. 8.

The seals discussed herein may be made of a variety of compressible materials, e.g., metals, that may be selected based on the needs of a particular environment, e.g., materials that are corrosion-resistant, capable of tolerating high heat, etc. For example, such seals may be made of materials such as Inconel-718, Hastelloy C22, SS-316L stainless steel, oxygen-free electronic (OFE) copper, etc. The interiors of such seals may, in some implementations, be hollow, i.e., there may be no solid material within the interior profile.

The exterior diameter of the cross-sectional shapes of the seals discussed herein may be selected to allow any of a variety of diameters, e.g., between 3 mm and 25 mm, for example, to be used for the exterior profile of the cross-sectional shapes of such seals.

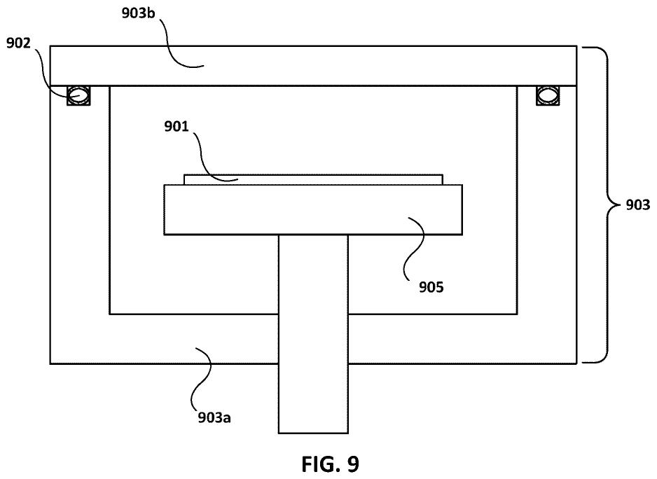

As discussed above, seals such as those discussed herein may be used to seal interfaces between components used in semiconductor processing equipment. FIG. 9 depicts a diagram of a semiconductor processing chamber implementing a metal O-ring seal as discussed herein. For example, the semiconductor processing chamber 903 may include a main body 903a, e.g., a first component of a semiconductor processing tool, and a lid 903b, e.g., a second component of a semiconductor processing tool, that may be fastened to the main body 903a using a plurality of fasteners, e.g., screws (not shown). A metal O-ring seal 902, e.g., having a cross-section such as discussed above, may be installed in the interface between the main body 903a and the lid 903b. A pedestal 905 may be located within the sealed environment of the processing chamber 903 and may be used to support a semiconductor wafer 901 within the processing chamber 903 during wafer processing operations. Of course, it will be understood that such metal O-ring seals may be used at any sealable interface of such semiconductor processing tools, including, for example, between valves and housings, valves and manifolds, conduits and housings, pumps and housings or conduits, etc.

The use, if any, of ordinal indicators, e.g., (a), (b), (c) . . . or (1), (2), (3) . . . or the like, in this disclosure and claims is to be understood as not conveying any particular order or sequence, except to the extent that such an order or sequence is explicitly indicated. For example, if there are three steps labeled (i), (ii), and (iii), it is to be understood that these steps may be performed in any order (or even concurrently, if not otherwise contraindicated) unless indicated otherwise. For example, if step (ii) involves the handling of an element that is created in step (i), then step (ii) may be viewed as happening at some point after step (i). Similarly, if step (i) involves the handling of an element that is created in step (ii), the reverse is to be understood. It is also to be understood that use of the ordinal indicator “first” herein, e.g., “a first item,” should not be read as suggesting, implicitly or inherently, that there is necessarily a “second” instance, e.g., “a second item.” It is to be understood that the phrases “for each <item> of the one or more <items>,” “each <item> of the one or more <items>,” or the like, if used herein, are inclusive of both a single-item group and multiple-item groups, i.e., the phrase “for . . . each” is used in the sense that it is used in programming languages to refer to each item of whatever population of items is referenced. For example, if the population of items referenced is a single item, then “each” would refer to only that single item (despite the fact that dictionary definitions of “each” frequently define the term to refer to “every one of two or more things”) and would not imply that there must be at least two of those items. Similarly, the term “set” or “subset” should not be viewed, in itself, as necessarily encompassing a plurality of items—it will be understood that a set or a subset can encompass only one member or multiple members (unless the context indicates otherwise).

The term “between,” as used herein and when used with a range of values, is to be understood, unless otherwise indicated, as being inclusive of the start and end values of that range. For example, between 1 and 5 is to be understood to be inclusive of the numbers 1, 2, 3, 4, and 5, not just the numbers 2, 3, and 4.

The term “operatively connected” is to be understood to refer to a state in which two components and/or systems are connected, either directly or indirectly, such that, for example, at least one component or system can control the other. For example, a controller may be described as being operatively connected with a resistive heating unit, which is inclusive of the controller being connected with a sub-controller of the resistive heating unit that is electrically connected with a relay that is configured to controllably connect or disconnect the resistive heating unit with a power source that is capable of providing an amount of power that is able to power the resistive heating unit so as to generate a desired degree of heating. The controller itself likely cannot supply such power directly to the resistive heating unit due to the currents involved, but it will be understood that the controller is nonetheless operatively connected with the resistive heating unit.

It is understood that the examples and implementations described herein are for illustrative purposes only and that various modifications or changes in light thereof will be suggested to persons skilled in the art. Although various details have been omitted for clarity's sake, various design alternatives may be implemented. Therefore, the present examples are to be considered as illustrative and not restrictive, and the disclosure is not to be limited to the details given herein but may be modified within the scope of the disclosure.

It is to be understood that the above disclosure, while focusing on a particular example implementation or implementations, is not limited to only the discussed example, but may also apply to similar variants and mechanisms as well, and such similar variants and mechanisms are also considered to be within the scope of this disclosure.

1. An apparatus comprising:
a segment of compressible material, wherein:
the segment of compressible material has a constant cross-sectional shape along a first path,
the cross-sectional shape has an exterior profile and an interior profile,
the exterior profile has a nominally circular shape of radius R,
the interior profile has a non-circular shape with a maximum dimension along a first reference axis that intersects the interior profile at two locations,
the interior profile has a transverse dimension along a second reference axis that is perpendicular to the first axis and positioned midway between the two locations where the first reference axis intersects the interior profile, and
the maximum dimension is larger than the transverse dimension.

2. The apparatus of claim 1, wherein:
the maximum dimension is greater than or equal to 1.6·R and less than or equal to 1.8·R, and
the transverse dimension is greater than or equal to 1.4·R and less than or equal to 1.6·R.

3. The apparatus of claim 1, wherein the maximum dimension is about 1.8·R and the transverse dimension is about 1.4·R.

4. The apparatus of claim 1, wherein the maximum dimension is about 1.8·R and the transverse dimension is about 1.5·R.

5. The apparatus of claim 1, wherein the maximum dimension is about 1.8·R and the transverse dimension is about 1.6·R.

6. The apparatus of claim 1, wherein the maximum dimension is about 1.7·R and the transverse dimension is about 1.4·R.

7. The apparatus of claim 1, wherein the maximum dimension is about 1.7·R and the transverse dimension is about 1.5·R.

8. The apparatus of claim 1, wherein the maximum dimension is about 1.7·R and the transverse dimension is about 1.6·R.

9. The apparatus of claim 1, wherein the maximum dimension is about 1.6·R and the transverse dimension is about 1.4·R.

10. The apparatus of claim 1, wherein the maximum dimension is about 1.6·R and the transverse dimension is about 1.5·R.

11. The apparatus of claim 1, wherein the interior profile is symmetric across both the first reference axis and the second reference axis.

12. The apparatus of claim 1, wherein:
the interior profile is divided into four quadrants by the first reference axis and the second reference axis, and
the portion of the interior profile within each quadrant has a maximum slope angle change of 90° or less.

13. The apparatus of claim 1, wherein:
the cross-sectional shape has first thicknesses defined by distances between the interior profile and the exterior profile along the first reference axis and second thicknesses defined by distances between the interior profile and the exterior profile along the second reference axis, and
the second thicknesses are each at least 25% larger than the first thicknesses.

14. The apparatus of claim 13, wherein the second thicknesses are each no more than 200% larger than the first thicknesses.

15. The apparatus of claim 1, wherein:
the interior profile lies entirely within a region bounded by an outer perimeter and an inner perimeter;
the outer perimeter is offset radially outward from a reference interior profile by 0.05·R;
the inner perimeter is offset radially inward from the reference interior profile by 0.05·R;
the first reference axis and the second reference axis intersect at an intersection point;
the reference interior profile is a closed spline that passes through a set of eight points, the set of eight points including:
two points that are positioned on either side of the intersection point and along the first reference axis such that each is at a distance X from the intersection point,
two points that are positioned on either side of the intersection point and along the second reference axis such that each is at a distance Y from the intersection point,
two points that are positioned on either side of the intersection point and along a third reference axis such that each is at the distance Y from the intersection point, wherein the third reference axis is at a 60° angle with respect to the first reference axis, and
two points that are positioned on either side of the intersection point and along a fourth reference axis such that each is at the distance Y from the intersection point, wherein the fourth reference axis is a mirror image of the third reference axis with respect to the second reference axis; and
X is equal to 0.85·R and Y is equal to 0.75·R.

16. (canceled)

17. The apparatus of claim 15, wherein:
the segment is a closed loop that follows a path,
the path defines a reference plane,
the second reference axis is nominally perpendicular to the reference plane, and the path is circular, obround, or rectangular with rounded corners.

18. (canceled)

19. (canceled)

20. (canceled)

21. The apparatus of claim 16, further comprising:
a first component of a semiconductor processing tool; and
a second component of the semiconductor processing tool, wherein the segment of compressible material is compressed between the first component and the second component so as to form a sealed interface between the first component and the second component.

22. The apparatus of claim 1, wherein there is no solid material within the interior profile.

23. The apparatus of claim, 1 wherein the interior profile and the exterior profile are both closed profiles.

24. (canceled)

25. The apparatus of claim 1, wherein the compressible material is a metal, Inconel-718, Hastelloy C22, SS-316L stainless steel, oxygen-free electronic (OFE) copper, or other similar metallic material.

26. The apparatus of claim 1, wherein R is a value greater than or equal to 1 mm and less than or equal to 25 mm.
